(19) United States
(12) Patent Application Publication
(10) Pub. No.: US 2024/0151966 A1
(43) Pub. Date: May 9, 2024

(54) METHOD FOR OPERATING A PAIR OF SMART GLASSES AND SMART GLASSES

(71) Applicant: Robert Bosch GmbH, Stuttgart (DE)

(72) Inventors: Johannes Meyer, Haseluenne (DE); Johannes Fischer, Pliezhausen (DE); Thomas Alexander Schlebusch, Renningen (DE)

(21) Appl. No.: 18/455,765

(22) Filed: Aug. 25, 2023

(30) Foreign Application Priority Data
Nov. 4, 2022 (DE) 10 2022 211 635.6

(51) Int. Cl. G02B 27/00; G02B 27/01

(52) U.S. Cl. CPC G02B 27/0093; G02B 27/0172

(57) ABSTRACT

A method for operating a pair of smart glasses. The method includes a step of outputting a wavelength-modulated light beam by a light source to an eye of a user of the smart glasses, the light beam being output utilizing a movable mirror element in a state of rest. The method also includes a step of receiving a portion of the wavelength-modulated light beam, reflected from a reflection point, as reflection beam. The method further includes a step of ascertaining a wavelength difference between the reflection beam and the wavelength-modulated light beam, utilizing a laser feedback interferometry sensor. The method also includes a step of determining a distance d between the light source 135 and the reflection point, utilizing the wavelength difference.

### CROSS REFERENCE

The present application claims the benefit under 35 U.S.C. § 119 of German Patent Application No. DE 10 2022 211 635.6 filed on Nov. 4, 2022, which is expressly incorporated herein by reference in its entirety.

### FIELD

The present invention relates to a method for operating a pair of smart glasses, and smart glasses. The subject matter of the present invention is also a computer program.

### BACKGROUND INFORMATION

In operating modern smart glasses, there is often the problem of detecting the position of the eye or a part of the eye in relation to the smart glasses. However, the knowledge of this position has exceptional influence on the ability to focus or sharply image a projection of symbols into the eye or onto the retina. In conventional methods heretofore, the distance between the light source or the projector and, for example, the eye or the retina was only estimated generally, so that especially if the smart glasses slipped, sharp focusing of the imaging of symbols or characters onto the retina could be problematic or at least could not be accomplished optimally.

### SUMMARY

The approach presented here according to the present invention provides a method for operating a pair of smart glasses, in addition a device which uses this method, and finally a corresponding computer program. Advantageous example embodiments, further developments of, and improvements of the present invention are made possible by the measures disclosed herein.

The present invention presented here provides a method for operating a pair of smart glasses. According to an example embodiment of the present invention, the method includes the following steps:
Output of a wavelength-modulated light beam by a light source to an eye of a user of the smart glasses, the light beam being output utilizing a movable mirror element in a state of rest;
Receiving a portion of the wavelength-modulated light beam, reflected from a reflection point, as reflection beam;
Ascertaining a wavelength difference between the reflection beam and the wavelength-modulated light beam, utilizing laser feedback interferometry; and
Determining a distance between the light source and the reflection point, utilizing the wavelength difference.

A wavelength-modulated light beam may be understood to be a light beam or a bundle of light rays whose intensity or wavelength is changed according to a predefined modulation pattern. A reflection point may be understood to be a position at which a portion of the light of the light beam is reflected, the reflected portion being returned as reflection beam.

The present invention presented here is based on the recognition that by the output of a wavelength-modulated light beam and the corresponding receiving of the reflection beam, using laser feedback interferometry, it is possible to determine a wavelength at which a corresponding laser unit vibrates in resonance, since at this wavelength, an intensity maximum may be detected in the spectrum. By knowing the position of this intensity maximum, it is now possible to infer the distance the reflection point is from the light source. In doing so, the fact is utilized that by the reflection of the light beam at the reflection point, the resonator cavity of a laser unit as light source is virtually “elongated”, and through the position of an intensity maximum of a specific wavelength, it is possible to infer the “length” of such a simulated resonator cavity. For example, if the length of the light source itself is now subtracted from this ascertained “length” of the resonator cavity, from this it is possible to ascertain a distance of the reflection point to the light source, especially to the exit area of the light beam from the light source. Given a known length of the light source and possibly suitable optical elements in the light path of the light beam, the position of the reflection point may thus be determined, so that in a following step, for example, focusing of the emission of light for imaging a symbol may be altered or optimized by the use of this distance. In this way, the display or projection of symbols into the eye or onto the retina may be improved considerably.

One specific example embodiment of the present invention presented here is particularly favorable, in which in the output step, the light beam is output utilizing a resting mirror element, in particular, the mirror element being formed as part of a scanner system for radiating an image onto the eye. Such a specific embodiment of the approach proposed here offers the advantage of permitting a precise measurement or ascertainment of the distance between the light source and reflection point. In particular, a movable mirror of a scanner system may be employed here, which likewise is used for the output of images onto or into the eye, so that the distance may also be determined very easily using components that are already available.

According to a further specific example embodiment of the present invention, in the output step, an infrared laser beam may be output as light beam. Such a specific embodiment of the approach according to the present invention offers the advantage that the light beam for determining the distance is not seen by a user of the smart glasses, and thus is not perceived as annoying.

In addition, a specific embodiment of the approach presented here according to the present invention is advantageous in which in the output step, the light beam is wavelength-modulated by modulation of a current and/or by an FMCW modulation, and/or the light beam is wavelength-modulated utilizing a triangle-shaped, sawtooth-shaped, trapezoidal, sinusoidal, rectangular and/or stepped modulation. Such a specific embodiment offers the advantage of achieving a correspondingly desired modulation of the wavelength of the light beam or of partial light beams of a bundle of light rays, utilizing technically simple measures.

According to another specific embodiment of the approach proposed here according to the present invention, the ascertaining step may be carried out utilizing a Fourier transform and/or a discrete wavelet transform. By using such a transform, a corresponding wavelength or an intensity maximum at a corresponding wavelength may be identified very easily, permitting efficient determination of the distance between the light source and the reflection point. Through the knowledge, ascertained in advance, of the correlation characteristic for laser feedback interferometry between a wavelength of an intensity maximum of the frequency of the reflection beam relative to a distance of the point from which a portion of the light beam is reflected, to the light source, may then also be determined very easily by ascertaining the distance of the light source from the reflection point.

Also advantageous is a specific embodiment of the approach proposed here, in which in the ascertaining step, the wavelength difference is ascertained between two intensity maxima of a spectrum formed from the reflection beam. Especially if multiple optical elements are disposed in an optical axis of the light beam, from each of which a portion of the light beam is reflected, usually multiple intensity maxima may also appear in the evaluated spectrum. By ascertaining the wavelength difference between two intensity maxima in this spectrum, a distance of the reflection point from the light source may thus be ascertained very easily.

In order to permit the most precise possible focusing or guidance of the light beam or an imaging by way of this light beam, according to one further specific embodiment of the approach presented here according to the present invention, in the receiving step, the reflection beam may be received from an optical element and/or a portion of an eye as reflection point.

The distance of a reflection point as far away as possible from the light source may be ascertained because in the ascertaining step, the intensity maximum detected in connection with the greatest ascertained wavelength of the spectrum is utilized, the distance between the light source and a retina of an eye as reflection point being determined in the determining step. Such a specific embodiment offers the advantage, by using the intensity maximum with the greatest ascertained wavelength of the spectrum, to also ascertain the distance of that reflection point which is furthest away from the light source. In this way, the distance of the retina of a user of the smart glasses is ascertained very reliably, which may be used very efficiently for adjusting the light emission and thus for the sharp imaging of a symbol in the eye of this user of the smart glasses.

According to a further specific embodiment of the present invention, a step of detecting an alignment of the eye and/or a position of a pupil of the eye may be provided, at least the output step being carried out as a function of the detected alignment and/or position of the eye. Thus, for example, it is possible to recognize when a viewing direction has changed or the smart glasses have slipped, so that for these cases, the distance between the light source and the reflection point may be redetermined, which is particularly important for a focused and sharp output of images to the retina of the eye. On the other hand, if it is determined that the viewing direction or the position of the pupil has not changed, detecting the distance again between the reflection point and the light source is more likely not so relevant, since from previous experience, a distance ascertained in a preceding measuring cycle ought not to have changed in a value range relevant for the precise output of an image.

For example, in order also to be able to produce multiple eye boxes using as few technical components as possible, and thus to save on structural elements, optical segmentation elements may be placed in the optical axis of the light beam which may be used as beam splitters, for instance, for splitting a light beam into multiple partial light beams. In this case, of each of the partial light beams, a corresponding reflection beam is then reflected back at different reflection points, which may then be used for evaluating a distance of these respective reflection points according to the procedure presented above. Thus, one specific embodiment of the approach proposed here is particularly advantageous, in which in the output step, the light beam is output to at least two optical segmentation elements separated and/or delimited by an edge, the steps of receiving, ascertaining and determining being carried out for each of multiple reflection beams, in order to ascertain for each a distance between the light source and one of various reflection points, the reflection beams being obtained from the light beam by a reflection and/or refraction at different segmentation elements and a corresponding reflection at one of the various reflection points.

The use of one specific embodiment of the approach proposed here according to the present invention is very advantageous, in which in the output step, the light beam is output as a ray bundle of partial light beams to a one-piece lens as segmentation element, one partial beam each being output to a different section of the lens, the sections being separated from each other by an edge. Such a specific embodiment offers the advantage of easy mechanical production, since only a single optical element, namely, the segmentation element, needs to be mounted on the corresponding lens.

One specific example embodiment of the approach proposed here according to the present invention is particularly favorable, having a step of emitting an imaging light beam for imaging a symbol in the eye, the emitting step being carried out utilizing the distance, in particular, the imaging light beam being emitted by the light source and/or the imaging light beam and the light beam being output into one shared optical path. A very efficient and sharp focused imaging of a symbol into the eye or onto the retina of the eye of the user of the smart glasses may thus be realized. At the same time, an apparatus or smart glasses provided for the output of images may be used with slight modifications for detecting the indicated distance, as well, resulting in a considerable increase in value of such an apparatus or smart glasses.

For example, this method according to the present invention may be implemented in software or hardware or in a mixed form of software and hardware, e.g., in a control unit.

The approach introduced here according to the present invention also provides a device, particularly smart glasses, which is designed to carry out, control or implement the steps of a variant of a method presented here according to the present invention, in corresponding units. The object of the present invention may be achieved quickly and efficiently by this embodiment variant of the invention in the form of a device, as well.

To that end, the device according to the present invention may have at least one arithmetic logic unit for the processing of signals or data, at least one memory unit for storing signals or data, at least one interface to a sensor or an actuator for reading in sensor signals from the sensor or for the output of data signals or control signals to the actuator and/or at least one communication interface for the read-in or output of data which is embedded into a communication protocol. The arithmetic logic unit may be a signal processor, a microcontroller or the like, for example, while the memory unit may be a flash memory or a magnetic memory unit. The communication interface may be adapted to read in or output data in wireless and/or line-conducted fashion, a communication interface which is able to read in or output line-conducted data having the capability to read in this data electrically or optically from a corresponding data-transmission line, for example, or to output it into a corresponding data-transmission line.

In the present case, a device may be understood to be an electrical device which processes sensor signals and outputs control signals and/or data signals as a function thereof. The device may have an interface which may be implemented in hardware and/or software. If implemented in hardware, the interfaces may be part of what is referred to as a system ASIC, for example, that includes a wide variety of functions of the device. However, it is also possible that the interfaces are separate integrated circuits or are made up at least partially of discrete components. If implemented in software, the interfaces may be software modules which are present in a microcontroller, for example, in addition to other software modules.

Of advantage is also a computer-program product or computer program having program code that may be stored on a machine-readable data carrier or storage medium such as a semiconductor memory, a hard disk memory or an optical memory and is used to carry out, implement and/or control the steps of the method according to one of the specific embodiments of the present invention described above, especially when the program product or program is executed on a computer or a device.

Exemplary embodiments of the approach presented here are represented in the figures and explained in greater detail in the following description.

### BRIEF DESCRIPTION OF THE DRAWINGS

FIG. 1 shows a schematic representation of a pair of smart glasses having a device according to one exemplary embodiment of the present invention.

FIG. 2 shows a schematic representation of an imaging of an eye by the optical receiver, according to an example embodiment of the present invention.

FIG. 3 shows a schematic representation or imaging of the eye by a two-dimensional rendering of the reflectance behavior of the eye at different reflection points on the exterior of the eye, according to an example embodiment of the present invention.

FIG. 4 shows a schematic representation of a 3-D model of the eye, according to an example embodiment of the present invention.

FIG. 5 shows a schematic representation of a pinhole-camera model, according to an example embodiment of the present invention.

FIG. 6 shows in two diagrams, a time characteristic of a control of a movement of a mirror during the image build-up upon the output of an image or symbol, according to an example embodiment of the present invention.

FIG. 7 shows in two diagrams, a 2-D distance spectrum for multiple successive delta modulations plotted as intensity over wavelength λ, as well as the averaged distance spectrum, according to an example embodiment of the present invention.

FIG. 8 shows in two sub-diagrams, an intensity distribution over the detected wavelengths, as are already shown in FIG. 7.

FIG. 9 shows a schematic representation of a layout of components with which a vertex distance may be determined using a segment lens, according to an example embodiment of the present invention.

FIG. 10 shows a representation of an image, as obtained by the irradiation of light onto the segment edge and a corresponding reflection at reflection points, according to an example embodiment of the present invention.

FIG. 11 shows a diagram, similar to the representation of the upper sub-diagram from FIGS. 7 and 8, which now shows a corresponding distribution in the distance spectrum with the 4 focal lengths for four virtual cameras, according to an example embodiment of the present invention.

FIGS. 12A-12C show in several sub-representations, a correlation in principle between different distances and the associated measured values, according to an example embodiment of the present invention.

FIG. 13 shows a flowchart of a method according to one exemplary embodiment of the present invention.

FIG. 14 show a block diagram of an exemplary embodiment of a device for operating a pair of smart glasses, according to the present invention.

### DETAILED DESCRIPTION OF EXAMPLE EMBODIMENTS

In the following description of advantageous exemplary embodiments of the present invention, the same or similar reference numerals are used for the similarly functioning elements shown in the various figures, a description of these elements not being repeated.

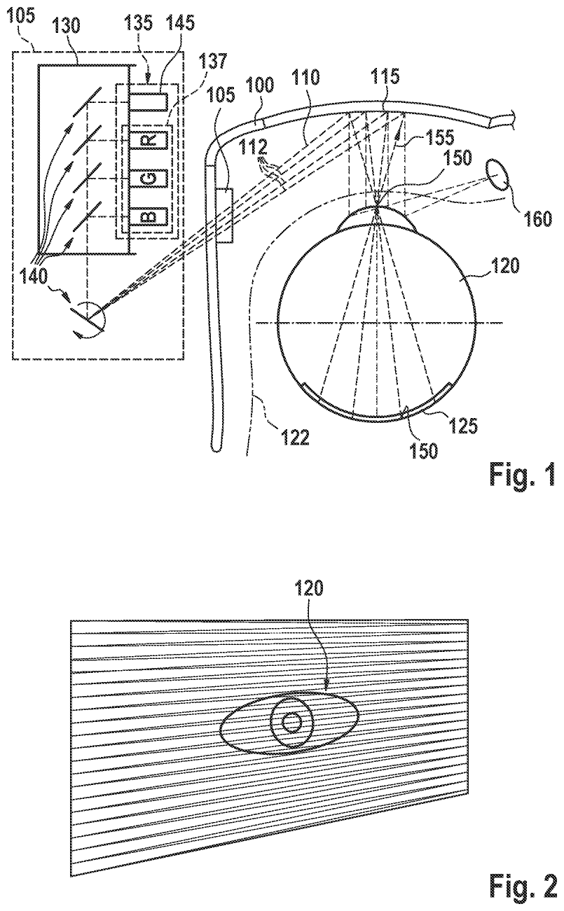

FIG. 1 shows a schematic representation of a pair of smart glasses 100 having a device 105 according to one exemplary embodiment. For example, device 105 is mounted on a bow of the smart glasses and is designed to output a light beam 110 which, for instance, may also contain multiple partial light beams 112, to an optical element 115. Optical element 115 is placed as a hologram or coating on or in a glass of the smart glasses, for instance, and is designed to direct irradiated light beam 110 in the direction of an eye 120 of a user 122 of smart glasses 100.

In order now to be able to project a symbol onto eye 120, especially onto retina 125 of eye 120, a scanner system 130 is used in device 105, as illustrated in greater detail in the enlarged representation on the left side in FIG. 1. Device 105 includes a light source 135 in the form of a laser module, for example.

Besides RGB lasers 137 (for the projection of an image or symbol onto movable MEMS mirrors 140), the laser module or light source 135 also includes a laser feedback interferometry sensor 145 and is integrated together with scanner system 130 into the frame of smart glasses 100. For instance, this laser feedback interferometry sensor 145 emits light not visible to the human eye (in this case, infrared light). This light is redirected as light beam 110 via a scanner like MEMS micromirrors 140 and directed to optical element 115 (which, for example, takes the form of a mirror, HOE [holographic optical element], prism or the like). This optical element 115 then redirects light 110 to eye 120. From eye 120, light 120 [sic] is reflected at at least one reflection point 150, e.g., on the cornea or retina 125 of eye 120, so that a portion of the light is reflected back as reflection beam 155 into the optical path and is detected by laser feedback interferometry sensor 145 and evaluated. For the area in which light strikes retina 125, the light of light beam 110 is thus reflected back “on axis” (bright pupil effect) and arrives via scanner 140 [sic] back into the cavity of LFI laser sensor 145. There, it is detected with the aid of a photodiode integrated into the cavity and an image may likewise be reconstructed.

Reflections may also be detected “off axis” (dark pupil effect) at corresponding reflection points 150, especially on the exterior of eye 120, by an optical receiver 160, e.g., a photodiode, which is mounted outside of the laser module or device 105 in the frame of smart glasses 100. By continuous scanning of the position of mirrors 140 as well as of the light measured by optical receiver 160, i.e., the photodiode, from that, it is possible to ascertain a two-dimensional image of the surface reflectivity of eye 120 as well as of eyelids.

FIG. 2 shows a schematic representation of an imaging of an eye 120 by optical receiver 160, the position of eye 120 being detected in a horizontal and a vertical direction. This FIG. 2 thus shows a possible scan region over eye 120.

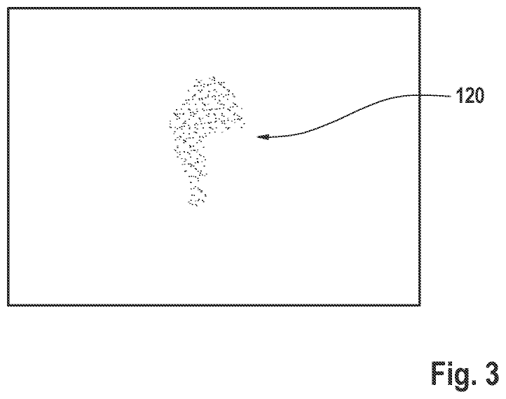

FIG. 3 shows a schematic representation or imaging of eye 120 by a two-dimensional rendering of the reflectance behavior of the eye at different reflection points 150 on the exterior of eye 120.

The advantage of the image from optical receiver 160 lies in the fact that a pupil of eye 120 is able to be detected directly in the sensor signal and the image is particularly robust with respect to extraneous light. Thus, an extremely energy-efficient determination of the eye position may be achieved by using this method. The disadvantage lies in the lack of context information as to where the pupil is relative to the eye. The pupil position may change first of all due to a change of the eye position, and secondly due to slipping of the glasses. As a result, the gaze vector cannot be detected robustly. To remedy this, a model-based eye-tracking approach may be used.

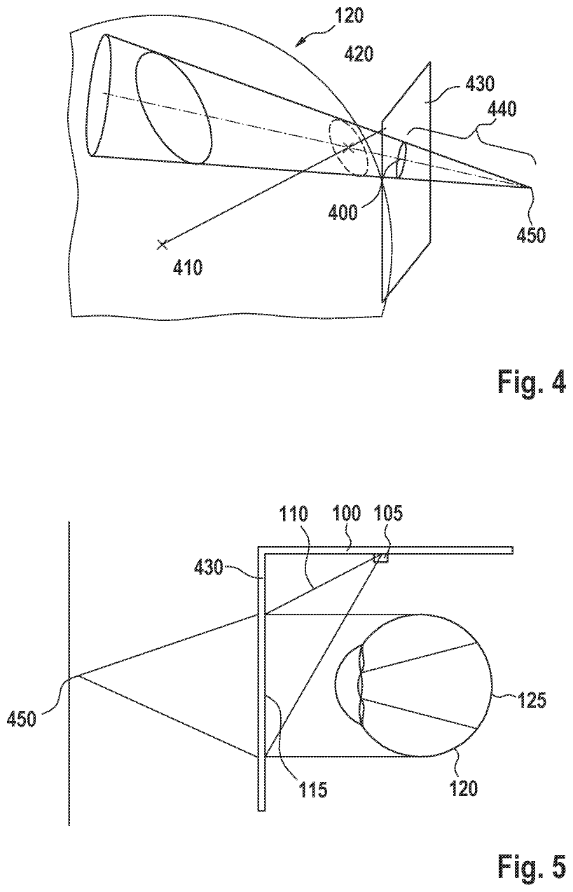

FIG. 4 shows a schematic representation of a 3-D model of eye 120, which is made up of a center 400 and diameter of the pupil, as well as center 410 and diameter 420 of eye 120. Given known camera parameters (pinhole camera model made up of image plane

I 430, focal distance f 440, sensor-pixel size and nodal point 450), via the model and a series of detected pupils (e.g., corresponding to the representation from FIG. 3), the position and orientation of the pupil and thus of the sclera may be ascertained from the 2-D image via a 2D-3D conical projection.

FIG. 5 shows a schematic representation of a pinhole-camera model for clarifying a projection of images or symbols onto an ocular fundus or retina 125. Provided here again on a pair of smart glasses 100 is a device 105 which outputs light beam 110 to optical element 115 on the smart glasses. In using this model-based eye-tracking approach for the scanned laser system from FIG. 1, a corresponding camera model (e.g., as pinhole camera) is thus to be determined for the laser system. Pixel size as well as the image size are obtained from the known geometric design of the optical system or may be determined via test grids (chessboard, lines, USAF chart, grids). In addition, the nodal point should be known, which lies in the point of origin of the scanner, that spans the scanning region on the optical element. Besides a tolerance or an angle between the temple stem and lens, often the focal length (i.e., the focal distance), upon which a sharp projection of a symbol or image onto retina 125 depends, is also unknown. This focal distance should additionally be determined for optimizing the output of images or symbols onto retina 125.

From the projector of device 105, a scanning field is spanned which is redirected preferably in parallel by the optical diverter or optical element 115, so that the laser beams strike eye 120. In this context, the scanner is rotated virtually behind the optical element, so that the image recorded is recorded centrally through the lens. Particularly advantageously, nodal point 450 at the same time lies centrally in the middle in the spanned field. Focal length (i.e., focal distance) f is thus obtained from the distance between nodal point 450 and the mean point of incidence on the lens, which here is assumed schematically as lying in image plane 430.

The FMCW modulation of utilized LFI sensor 145 from FIG. 1 may be employed to correctly determine the focal length or focal distance. The light emitted by this light source or the laser is wavelength-modulated by a modulation of the current (preferably delta modulation or, alternatively, also a modulation in sawtooth, trapezoidal, sinusoidal, rectangular or stair-pattern form, that is, in step-like fashion . . . ). Emitted light 110 is reflected by a surface (e.g., on the cornea or retina 125 of eye 120) at a reflection point 150 and is returned, that is, mirrored or reflected back into the laser cavity of sensor 1345 [sic], where it interferes with the locally oscillating electric field. The interference leads to a modulation of the optical power, which may be measured by a photodiode integrated into the cavity of the sensor or alternatively, via the monitoring of the voltage of the laser diode. The interference frequency may then be determined from the measured photodiode signal/voltage signal (e.g., with the aid of a calculation of the spectrum by FFT (fast Fourier transform) or DWT (discrete wavelet transform), and from that, the distance to the object may be determined.

To determine the focal length or focal distance, light beam 110 or the laser beam of LFI sensor 145 is then to remain centrally in the image region. This is given preferably when mirrors 140 of the scanner are not moving or the scanner is in its zero position. Thus, it is favorable, for example, to perform such a measurement when, after a projection travel for the output of an image or symbol, the mirrors, prior to the output of a new symbol or image, move back again into the starting position and are stopped briefly in the image center. Alternatively, mirrors 140 of the scanner may also be stopped at the corresponding position. Thus, the spectrum is recorded exemplarily or preferably after each image scan, after which the scanner is returned back to its original position/zero position and before the next image is recorded or output.

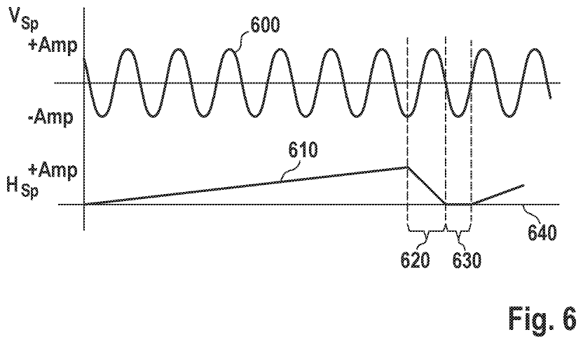

FIG. 6, in two diagrams, shows a time characteristic of a control of a movement of a mirror during the image construction, upon the output of an image or symbol. In this instance, FIG. 6 shows by way of example the mirror signals for controlling an MEMS-scanner mirror 140 having two dedicated micromirrors. The excursion of the vertical mirror is rendered in the top sub-diagram, whereas the excursion of the horizontal mirror is rendered in the bottom sub-diagram. The excursions are used in this case [sic]¹ linear and columnar construction of a projection of an image. In this context, the vertical mirror preferably oscillates resonantly with a sinusoidal function 600, and the horizontal mirror is controlled linearly, as represented by characteristic curve 610. During the return scan of the horizontal mirror in time interval 620, or alternatively, after completion of the return scan in time interval 630, the focal distance may be ascertained with the aid of LFI sensor 145 from FIG. 1, before a new scan with image construction takes place at a following point in time 640. ¹[Translator's note: Something missing in German, perhaps “for the”?]

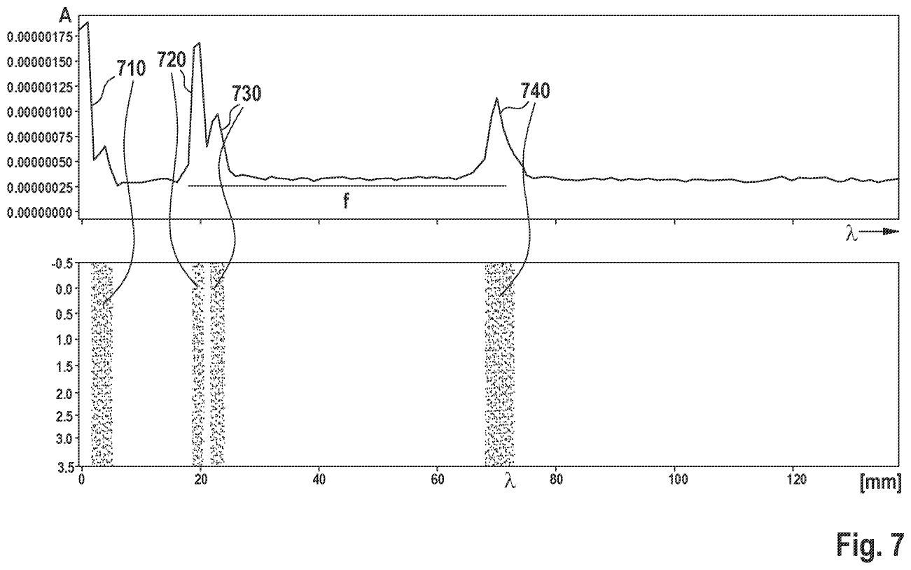

FIG. 7, in two diagrams, shows a 2-D distance spectrum for multiple successive delta modulations plotted as intensity A over wavelength λ (top sub-diagram) or focal distance f (bottom sub-diagram), as well as the averaged distance spectrum in the bottom sub-diagram of FIG. 7, so that this figure shows by way of example a measurement of a focal length or focal distance with the aid of the FMCW-modulated LFI sensor. In the spectrum of the LFI sensor signal, which is represented in the upper sub-figure of FIG. 7, a total of 4 signals may be discerned as intensity maxima. A difference f between individual intensity maxima may then be assigned to a corresponding distance d. It should be noted in this connection that wavelength difference f entered on the abscissa of the upper sub-diagram is not identical to the focal distance which is plotted on the abscissa of the upper sub-diagram, but rather wavelength difference f is connected with a scaling factor determined (in advance, for example), or according to a formulaic connection with focal distance f or the (additional) distance d. This scaling factor or formulaic connection may be determined in advance, for example, in a laboratory environment as a function of the geometric dimensions of the smart glasses or of the anticipated large position of the eyes, and stored in a memory, so that this scaling factor or formulaic connection may then be used directly in or on the smart glasses when wavelength difference f or the focal distance is to be converted into distance d. It should therefore be noted that the upper sub-diagram results, for example, from the averaging along the y-axis of the lower plot. Accordingly, mixed frequency f is represented on the x-axis. This mixed frequency corresponds via a scaling factor to the actual distance. The actual distance between 720 and 710 then corresponds to the focal distance of the virtual camera.

A first intensity maximum 710 here is caused by reflections of the integrated lenses, whereas a second intensity maximum 720 represents a partial reflection of first mirror 140. A third intensity maximum 730 results from a partial reflection of the second mirror of the scanner system and a fourth intensity maximum 740 results from a partial reflection of the optical diverter, denoted here as reflection point 150. The focal length or focal distance is obtained from the difference between the wavelengths of second intensity maximum 720 and fourth intensity maximum 740 and may thus also be ascertained directly from the spectral observation in a single measurement at runtime.

Consequently, focal length f of the virtual camera system may be ascertained. Since a partial reflection of the light occurs at each optical component in the beam path, a peak appears in the spectrum for each of these components, as represented in the upper sub-diagram of FIG. 7. Assuming the optical design is known, the peaks may be assigned to the optical components and between the origin of the laser, that is, in general the light source and, e.g., the lens as second-last optical component, the eye representing the last component.

In addition, a modeling of the laser scanner or of scanner system 130 may also be modeled [sic] in the form of a pinhole camera as eye-tracking sensor, which requires the determination of the focal distance in order to track robustly. This means that the laser scanner system may be imaged as a pinhole camera model, the laser source being realized as LFI sensor, so that the camera parameters (here especially the focal length or focal distance) may be measured over the same optical path, thus a projection of an image onto the eye may also be carried out.

In addition, with the approach presented here, it is also possible to detect an optical system in front of the eye. Besides the optical components in the system as well as the focal length or focal distance, it is also possible to recognize whether an object, preferably the eye, is located at a defined distance in laser or light beam 110, and based on this, to switch the projection on or off.

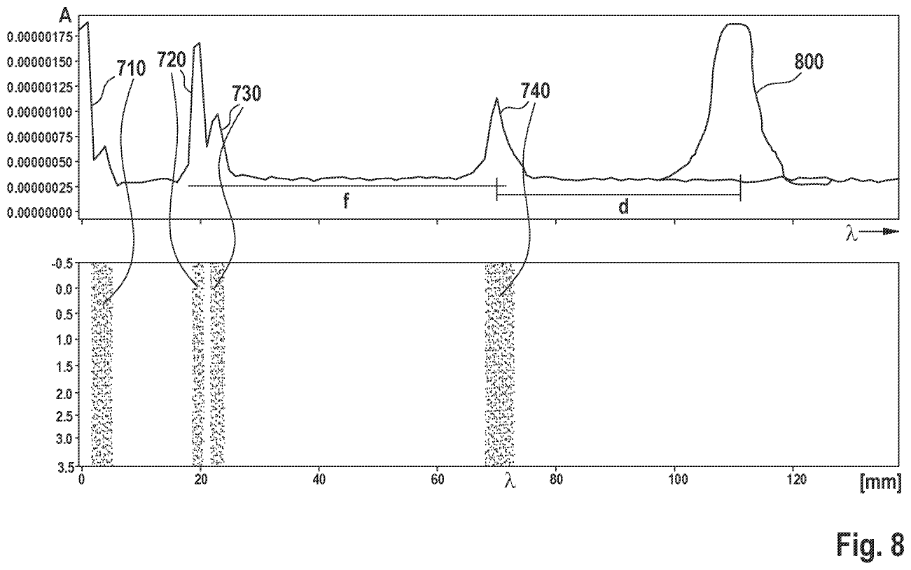

FIG. 8, in two sub-diagrams, shows an intensity distribution over the detected wavelengths and the distances to be determined therefrom, as are already shown in FIG. 7. In addition to the representation illustrated in FIG. 7, a last fifth wavelength, a last fifth intensity maximum 800, is now also rendered, which represents the greatest wavelength. This fifth intensity maximum 800 results from the fact that now a portion reflected at the cornea and at retina 125, respectively, is reflected into sensor 145, and here images an “elongation” of the cavity by the additional distance between the reflection point on the cornea and the reflection point on the retina. Thus, assuming distances between the individual components in the optical path are known, the concrete dimensions of the eye of the user of the smart glasses may then also be determined, so that these dimensions may then be used for the output of the symbol or image by the scanner, as well. In this way, the focusing and sharpness of the imaging of the objects on the retina may be improved considerably.

A vertex distance to the eye may thus be determined from the measurement as in FIG. 8, whereby the user-specific vertex distance, thus, distance d between lens and cornea or, if the laser beam falls into the eye, the depth and thus the diameter of the eye may be determined, as well. The color laser projection or the image-forming unit overall may be controlled based on vertex distance d, and, for example, the focal plane of the image projection may be readjusted according to the position of the glasses relative to the eye.

Moreover, a vertex distance to the eye may also be determined utilizing at least one segment lens.

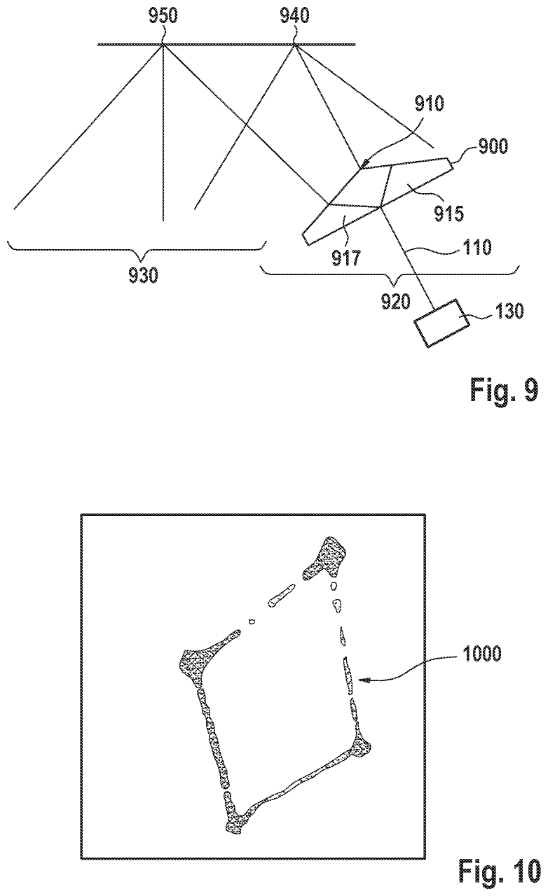

FIG. 9 shows a schematic representation of a layout of components with which a vertex distance may be determined utilizing such a segment lens 900. Segment lens 900 is formed in one piece, for example, and has an edge 910, so that segment lens 900 virtually forms two separate optical sub-elements 915, 917 when, as the case may be, a partial light beam of the light beam or bundle of light rays transits one of the parts of segment lens 900. Thus, for example, a method is realized for producing multiple eye boxes in which the image region is multiplied by the use of segmentation optical system 900, in that scanner system 130 or the laser scanner is scanned via segmentation optical system 900. FIG. 9 shows the optical path for a segmentation optical system 900 having two segments, which are separated from each other by edge 910. Because of the beam splitting at segmentation optical system 900, two virtual cameras 920 and 930 are thus “spanned”, each having a nodal point” 940 or 950 and each having its own focal length or focal distance. For this case, the focal distance is to be determined in each instance by the different optical path lengths. To that end, for example, the two scanning axes may be controlled in such a way that the respective beam path exits centrally in the particularly intended scanning region. The focal length or focal distance may then be determined one after the other for all virtual cameras (two in number in the example).

If the focal length or focal distance is sufficiently widely separated, the focal length or focal distance of all segments, here, of the two segments 915 and 917, may also be determined in one measurement. For that purpose, light beam 110, i.e., the laser beam is directed exactly to segment edge 910, for example, so that the power of laser beam 110 is split and comes from multiple segments (in the example, 4 segments) back into the laser.

FIG. 10 shows a representation of an image as obtained by the irradiation of light onto segment edge 910 and a corresponding reflection at reflection points. It is discernible that a rhombic pattern 1000 is obtained here as pattern of the reflections (e.g., in optical element 115).

FIG. 11 shows a diagram, similar to the representation of the upper sub-diagram from FIGS. 7 and 8, which now shows a corresponding distribution in the distance spectrum with the 4 focal lengths or focal distances for the four virtual cameras. The focal length or focal distance of each of the four virtual cameras extends in each case from the first mirror at second intensity maximum 720 to the peak at the respective point of incidence on optical diverting unit 1141, 1142, 1143 and 1144, each of these optical diverting units corresponding to a reflection point.

Moreover, model and eye parameters may also be determined with the approach presented here. Thus, in addition to the vertex distance, the diameter of the eye as well as the thickness of the eyelid and of the cornea may also be determined.

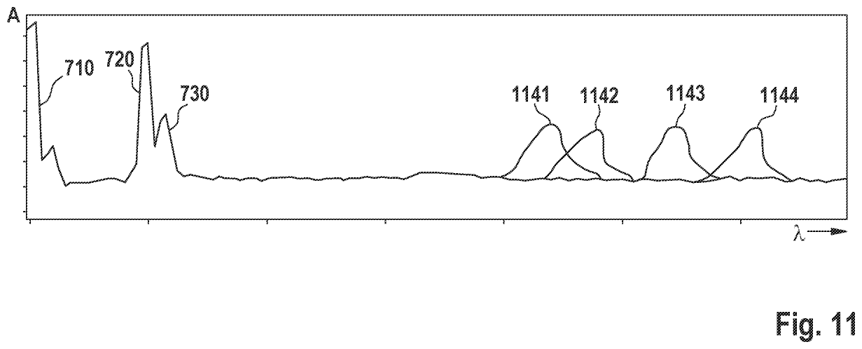

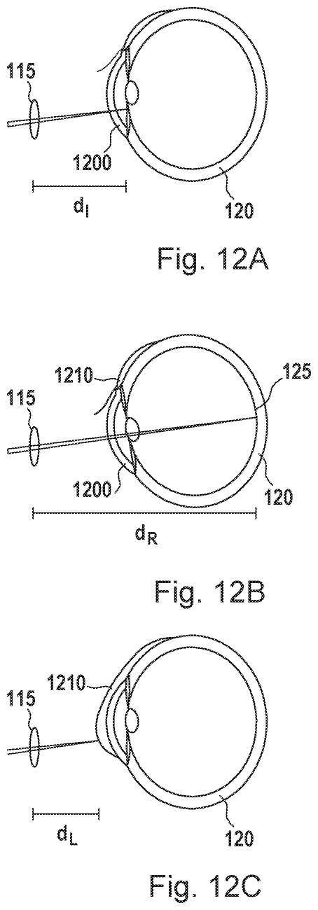

FIGS. 12A-12C, in several sub-representations, show a correlation in principle between different distances and the associated measured values. For example, in FIG. 12A (eye looking straight ahead) a distance d_{I} from optical element 115 up to iris 1200 of eye 120 is rendered, whereas FIG. 12B (eye looking downward) schematically represents a distance d_{R} from optical element 115 to retina 125 of eye 120. At the same time, it may also be seen in FIG. 12B that a movement of an eyelid 1210 may be detected or taken into account, as well. Finally, a distance d L from optical element 115 up to eyelid 1210 may be discerned in FIG. 12C (eye closed). If now, for instance, a series of depth measurements is carried out, the diameter of the eyeball may be determined from the difference between d_{R} and d_{I}, for example. The diameter of the eyeball varies depending on the defective eyesight of the wearer of the glasses, and the type of defective eyesight (nearsighted or farsighted) as well as the degree of defective eyesight may be determined in diopters by a corresponding comparison with a normal-sighted eye. As a result, in the case of defective vision, the image projection may be adjusted by adjusting the focal plane, for example. The wearing of a contact lens (which alters the optical property of the eye) may likewise be detected owing to a change in the signal strength (amplitude) of the reflex of eye 120. The geometric eye-tracking model may also be corrected when the condition “light beam (laser) strikes pupil” is detected, since in this case, the position of eye 120 relative to the laser is at least roughly known.

In addition, with the approach presented here, a design may also be realized in which LFI sensor 145 is integrated into the optical path. To do this, for example, sensor 145 may be coupled in between segment lens 900 and MEMS 140, e.g., with IR HOE between MEMS and segment lens. An infrared (IR) beam splitter may also be integrated into segment lens 900, and the IR light may be coupled from above into segment lens 900. Moreover, also possible is a use of the MEMS exit window for the integration of the IR coupling-in beam splitter there (e.g., as holographic beam splitter or classic beam splitter for IR wavelength). The IR-laser may also be placed as light source 135 over MEMS mirrors 140, so that light beam 110 falls at the flattest possible angle in the center of segment lens 900.

Through the approach presented here, the vertex distance may be determined continuously between projected images. Adaptive adjustment of the focal plane for the LBS scanner (control of a tunable lens) and activation of a laser projection may be carried out only when the smart glasses are also being worn. In addition, the focal length or focal distance between scanner and hologram may be determined for camera-based eye-tracking algorithms (mono camera and model-based approach/stereo/multi-camera approach with segmentation optical system and homography algorithm or 3-D pose estimation). Finally, model parameters may also be determined and taken into consideration for eye models in the model-based eye-tracking approach in the case of a projection.

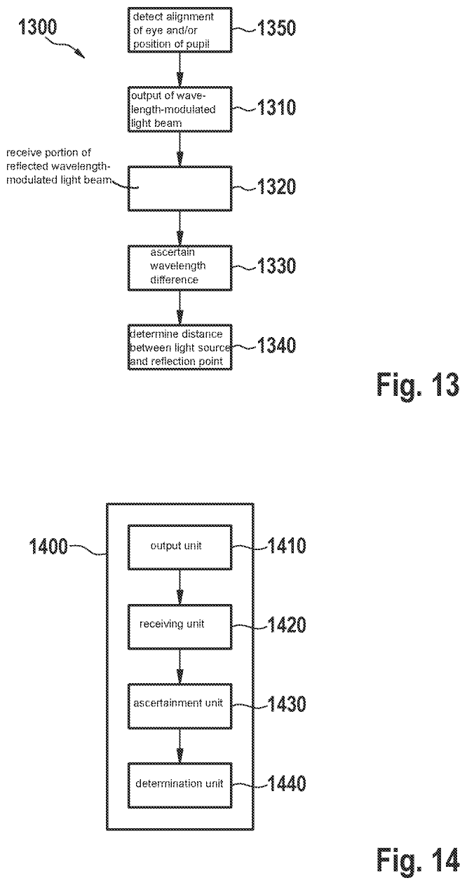

FIG. 13 shows a flowchart of an exemplary embodiment of a method 1300 for operating a pair of smart glasses. Method 1300 includes a step of the output 1310 of a wavelength-modulated light beam by a light source to an eye of a user of the smart glasses, the light beam being output utilizing a movable mirror element in a state of rest. Method 1300 also includes a step 1320 of receiving a portion of the wavelength-modulated light beam, reflected from a reflection point, as reflection beam. Method 1300 also includes a step 1330 of ascertaining a wavelength difference between the reflection beam and the wavelength-modulated light beam, utilizing a laser feedback interferometry sensor. Finally, method 1300 includes a step 1340 of determining a distance between the light source and the reflection point, utilizing the wavelength difference. Optionally, method 1300 includes a step 1350 of detecting an alignment of the eye and/or a position of a pupil of the eye, at least the output step being carried out as a function of the detected alignment and/or position of the eye.

FIG. 14 shows a block diagram of an exemplary embodiment of a device 1400 for operating a pair of smart glasses, device 1400 having an output unit 1410 for the output of a wavelength-modulated light beam by a light source to an eye of a user of the smart glasses, output unit 1410 being designed to output the light beam utilizing a movable mirror element in a state of rest. Device 1400 further includes a receiving unit 1420 for receiving a portion of the wavelength-modulated light beam, reflected from a reflection point, as reflection beam. The device also includes an ascertainment unit 1430 for ascertaining a wavelength difference between the reflection beam and the wavelength-modulated light beam, utilizing a laser feedback interferometry sensor. Finally, device 1400 includes a determination unit 1440 for determining a distance between the light source and the reflection point, utilizing the wavelength difference. Analogously, such a device may also have an apparatus for detecting an alignment of the eye and/or a position of a pupil of the eye, which is not shown explicitly in FIG. 14, at least the output step being carried out as a function of the detected alignment and/or position of the eye.

If an exemplary embodiment includes an “and/or” link between a first feature and a second feature, this is to be read to the effect that the exemplary embodiment according to one specific embodiment has both the first feature and the second feature, and according to a further specific embodiment, has either only the first feature or only the second feature.

What is claimed is:

1. A method for operating a pair of smart glasses, the method comprising the following steps:
outputting a wavelength-modulated light beam by a light source to an eye of a user of the smart glasses, the wavelength-modulated light beam being output utilizing a movable mirror element in a state of rest;
receiving a portion of the wavelength-modulated light beam, reflected from a reflection point, as a reflection beam;
ascertaining a wavelength difference between the reflection beam and the wavelength-modulated light beam, utilizing a laser feedback interferometry sensor; and
determining a distance between the light source and the reflection point, utilizing the wavelength difference.

2. The method as recited in claim 1, wherein in the output step, the mirror element is formed as part of a scanner system for radiating an image onto the eye.

3. The method as recited in claim 1, wherein in the output step, an infrared laser beam is output as the wavelength-modulated light beam.

4. The method as recited in claim 1, wherein in the output step, the wavelength-modulated light beam is wavelength-modulated by modulation of a current and/or by an FMCW modulation, and/or the light beam is wavelength-modulated utilizing a triangle-shaped and/or sawtooth-shaped and/or trapezoidal and/or sinusoidal and/or rectangular and/or stepped modulation.

5. The method as recited in claim 1, wherein the ascertaining step is carried out utilizing a Fourier transform and/or a discrete wavelet transform.

6. The method as recited in claim 1, wherein in the ascertaining step, the wavelength difference is ascertained between two intensity maxima of a spectrum formed from the reflection beam and/or utilizing the reflection beam.

7. The method as recited in claim 1, wherein in the receiving step, the reflection beam is received from an optical element and/or a portion of an eye as the reflection point.

8. The method as recited in claim 6, wherein in the ascertaining step, the intensity maximum detected in connection with a greatest ascertained wavelength of the spectrum is utilized, and in the determining step, the distance being determined between the light source and a retina of an eye as the reflection point.

9. The method as recited in claim 1, further comprising a step of detecting an alignment of the eye and/or a position of a pupil of the eye, at least the output step being carried out as a function of the detected alignment and/or position of the eye.

10. The method as recited in claim 1, wherein in the output step, the light beam is output to at least two optical segmentation elements separated and/or delimited by an edge, the steps of receiving, ascertaining, and determining being carried out for each of multiple reflection beams to ascertain for each a distance between the light source and one of various reflection points, the reflection beams being obtained from the light beam by a reflection and/or refraction at different segmentation elements and a corresponding reflection at one of the various reflection points.

11. The method as recited in claim 10, wherein in the output step, the light beam is output as a bundle of partial light beams to a one-piece lens as segmentation element, one partial beam each being output to a different section of the lens, the sections being separated from each other by an edge.

12. The method as recited in claim 1, further comprising emitting an imaging light beam for imaging a symbol in the eye, the emitting step being carried out utilizing the distance, the imaging light beam being emitted by the light source, the imaging light beam and the wavelength-modulated light beam being output into one shared optical path.

13. A device configured to operate a pair of smart glasses, the device configured to:
output a wavelength-modulated light beam by a light source to an eye of a user of the smart glasses, the wavelength-modulated light beam being output utilizing a movable mirror element in a state of rest;
receive a portion of the wavelength-modulated light beam, reflected from a reflection point, as a reflection beam;
ascertain a wavelength difference between the reflection beam and the wavelength-modulated light beam, utilizing a laser feedback interferometry sensor; and
determine a distance between the light source and the reflection point, utilizing the wavelength difference.

14. A non-transitory machine-readable storage medium on which is stored a computer program for operating a pair of smart glasses, the computer program, when executed by a method comprising the following steps:
output of a wavelength-modulated light beam by a light source to an eye of a user of the smart glasses, the wavelength-modulated light beam being output utilizing a movable mirror element in a state of rest;
receiving a portion of the wavelength-modulated light beam, reflected from a reflection point, as a reflection beam;
ascertaining a wavelength difference between the reflection beam and the wavelength-modulated light beam, utilizing a laser feedback interferometry sensor; and
determining a distance between the light source and the reflection point, utilizing the wavelength difference.
